(19) United States
(12) Patent Application Publication
(10) Pub. No.: US 2010/0313268 A1
(43) Pub. Date: Dec. 9, 2010

(54) METHOD FOR PROTECTING A COMPUTER AGAINST MALICIOUS SOFTWARE

(76) Inventors: Melih Abdulhayoglu, Montclair, NJ (US); Egemen Tas, Jersey City, NJ (US)

Correspondence Address: Richard Rowley, 525 Washington Blvd., Suite 1400, Jersey City, NJ, 07310, US

(21) Appl. No.: 12/672,550

(22) PCT Filed: Nov. 8, 2007
(86) PCT No.: PCT/US07/84078

§ 371 Date: Feb. 8, 2010

(51) Int. Cl. G06F 21/24

(52) U.S. Cl. 726/24

(57) ABSTRACT

A method of protecting a computer by having security software be set to clean mode where the clean mode acts as if files installed or modified before the clean date are safe and installed or modified after the clean date as potentially harmful.

### BACKGROUND

The Internet has become an integral part of almost every consumer's daily life. People shop online, browse websites, and many even telecommute to work. Unfortunately, the advances in Internet technology have also given rise to new threats. Identity theft is on the rise and new viruses, malware, adware, and other malicious programs emerge on an almost daily basis. Many people are becoming wary of their online activities and want to protect themselves and their computers from these growing threats.

Many companies have developed software products that help protect consumers against the growing threat of identity theft and malware. These include anti-virus products, firewalls, anti-spyware, and other similar software applications. These popular products are considered essential by many in protecting their computer and their personal lives while they are connected the internet. Unfortunately, many users find these products difficult to set up and use effectively. Firewalls are especially irritating for users as they tend to block and raise warnings about programs that the user already knows is safe.

Besides blocking Internet access to a program, a Firewall can also block many various program functions. For example, a single application may raise warning flags or block a program based on the application's attempt to access a third application in memory, execute an image, install a hook, terminate a separate application, install a device driver, send a message, access the COM interface, modify a registry key, modify a file or folder, or access the internet. The large number of warning messages and constant blocking can be a source of irritation for many users. Annoying security alerts and popups cause users to give up on their security efforts and often results in unsophisticated users disabling the firewall.

Typically, firewalls and other security software block application access by using a “black list” to deny certain application actions. A black list consists of a database that lists each program considered a threat by the firewall. Any application listed in the black list is denied access to the web or to other applications. This method of protection is easy for consumers to use as the user does not need to know what applications are safe before allowing the application to operate normally. However, this advantage is also a blacklist's major downfall. Black lists are severally limited in that the user or software vendor must know beforehand which sites and applications (collectively, the “Sites”) are dangerous and should be blocked by the software. This means that newly created or unknown dangerous applications can cause significant damage prior to their inclusion on the black list. The black list must be constantly updated to ensure that all of the unsafe applications are included and might accidentally include files that are actually safe (a false positive). In addition, less-sophisticated users may not be aware or know how to update a black list which limits their protection.

An alternate form of protection is known as a “white list”. White lists exclude all applications from accessing the Sites unless the application has first been added to a special database of allowed applications. This method of protection has significant advantages over a black list as unknown and new malware is not allowed to interact with the computer prior to its inclusion in the white list. This makes users safe against any new threats that might arise. The down-side of white lists is that they require a lot of configuration as each allowed application must be individually added to the list. For a typical computer user, this method requires a lot of work prior to performing a simple task such as simply surfing the web. Many users get frustrated with the white list approach and either abandon the software or turn off its protective features. A white list on a typical user's computer requires approval of a large volume of applications prior to normal use.

Anti-virus software and other security products all work in a manner similar to the methods described above. The software maintains a list of denied applications and will report the software as a virus or problem file if it is black-listed. Software is often black-listed when it is really safe and other software is not included in white-list when it should be. These are referred to as “false positives”. False positives happen on a frequent basis and are the cause of contention and litigation between security companies.

Some security software vendors maintain an independent white or black list which is updated regularly and supplied to the user. This is costly and difficult to due because of the large number of programs being released each year. In addition, a vendor-supplied list is difficult because of the constant debate over what actually constitutes malware or a virus. A vendor could easily include an application in its white list that is considered malware by some but not by others. This can throw doubt on the vendor's reputation and does not adequately meet the needs of more sophisticated users who don't want or need vendor interference. In addition, a company wrongly accused of developing and marketing malware or a virus can sue the company who makes a false positive which wastes precious resources on litigation.

Thus, there is a need to have a system that is easy to operate like a black list but provides the same white list protection against new threats. There is a need for security products that know what applications are safe without any intervention of a third party vendor or database. There is a real need for a security product that is both easy to install and use but that still provides flexible and powerful protection. There is also a need for a method that will reduce the number of false positives detected by a system.

### SUMMARY

The disclosed invention teaches that a computer can be secured against future and unknown malware threats using security software (such as a firewall or anti-virus product) that is operating in “clean mode”. Operating in clean mode is where the security software assume that all files installed or modified on a computer after a certain selected date (the “clean date”) are a potential threat and should be addressed.

The security software protects the computer by checking to see if a file trying to perform a function has a date later than the selected clean date. If the date is later, then the security software will either block the file or prevent the file from completing its task until further user input is received. A database can also be used to ensure that known safe files are not accidentally blocked after downloading or installing an update.

Alternatively, the security software can record which files are modified after the clean date in a database. The security software can then check the database to see if the file is included. If the file is included, the security software can take appropriate preventative actions.

The security software can also be set to check the code signing certificate or to see if the file is included in a trusted vendor database. If the code signing certificate is valid or it the file is in a trusted database, the file can perform its operations without interruption regardless of the file's date information or its inclusion or exclusion from the security software's database.

The firewall can be further customized by setting up a database to record file settings and modifications. This way the application can track file changes and modifications that might be made through updates. The firewall can then be set to allow these files

### BRIEF DESCRIPTION OF THE FIGURES

FIG. 1a shows a flowchart of an embodiment of the invention.

FIG. 1b shows a diagram of the operation of an embodiment of the invention.

FIG. 2a shows a flowchart of the invention with an added database feature.

FIG. 2b shows the diagram of the embodiment shown in FIG. 1 with the added database.

FIG. 3 shows a diagram of an alternate embodiment of the invention where date information does not need to be retrieved and examined.

FIG. 4 shows a diagram of a second alternate embodiment of the invention where all files existing on the computer prior to the clean date are recorded in a database.

### DETAILED DESCRIPTION

The following description includes specific details in order to provide a thorough understanding of the present invention and methods of using it. The skilled artisan will understand, however, that the system and methods described below can be practiced without employing these specific details. Indeed, they can be modified and can be used in conjunction with products and techniques known to those of skill in the art in light of the present disclosure.

Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment. References to accessing “Sites” or “sites” includes access to Internet sites, the computer's operating system, or third party programs. What process are included in the Sites (such as accessing the internet, installing a hook, installing a device driver, terminating an application, executing an image, modifying a registry key, modifying a file or folder, or accessing resource) is dependant on the configuration of the security software and includes any of the typical blocking, scanning, and removing performed by security software. Security software can include, but is not limited to, anti-virus programs, firewalls, memory overflow prevention systems, and other security products relying on the identification and prevention of malicious files. The reader should understand that the references to a “firewall” or “security software” include all other security programs employing the use of the invention in preventing the operations of malicious files.

The invention works on the premises that a computer is generally clean and free from malware, viruses, and Trojans prior to the installation of security software and that the security software is actually being installed in order to protect the user from future threats. For example, a new user who is buying a computer may purchase a computer that comes preinstalled with several software programs that known to be safe and do not need to trigger a security alarm or invoke any security prevention measures. At other times, a user may be confident that his machine is in working condition (such as by having a recent scan of the computer with an anti-virus program) but is concerned about accidentally installing unknown threats. The user in each of these cases has a strong interest in protecting their machine against future threats but do not need to worry about the files already installed on their computer.

Generally, the security software 4 will prevent future threats once the user of the computer instructs the security software 4 to enter “clean mode” (Step 102). This can be done automatically by the security software or by allowing a user to select an option to initiate clean mode using any normal method of selecting options in security software, such as by clicking a button, making a selection from a list, etc. Also, the security software can be set up so that it starts in “clean mode” when first installed on the computer or after the first time the security software is run the computer. Alternatively, the security software can be designed or programmed to have clean mode as the only available option. However, having clean mode as only one of many options allows the user to switch between typical methods of protection such as a full white list, full black list, or other protection scheme.

Once the security software is set to clean mode as described above, the security software will only allow files installed prior to a specific date and time to access the Sites or meets specific criteria (the remaining Steps as described in subsequent paragraphs). All other connections will either be blocked or flagged as potentially dangerous per typical security software operations. For firewalls this means blocking the network traffic of the application. For an anti-virus, this includes preventing the application from executing. The type of blocking and flagging depends primarily on the type of security protection intended as well as the design and programming that created the security software.

The date and/or time typically used by the security software in making the determination as to whether the file is safe or not is the date and time the user instructs the firewall to enter clean mode, but this can easily be set to any date and time desired, including, but not limited to, a date and time selected specifically by the user or the date and time that the security software was installed. It should be recognized that the security software can simply compare dates without considering or recording the time criteria at all. The date and/or time setting which is used by the security software to check to see if files are safe is herein referred to as the “clean date” 10.

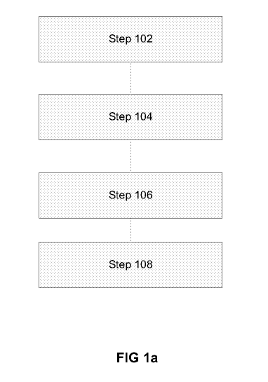

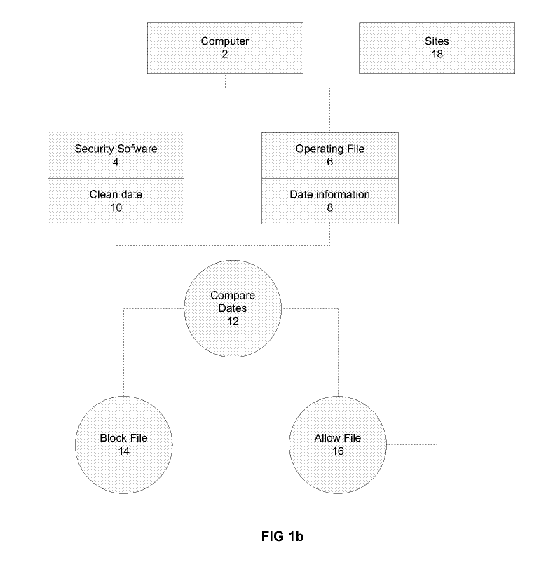

FIGS. 1a and 1b depict flowcharts of how one embodiment of the invention is implemented. In step 102, a user decides to secure the computer 2 against future threats and instructs the security software 4 to enter clean mode as described above. From this point forward the security software 4 will check the date information 8 associated with each operating file or file 6 that attempts to access the Sites 18 as depicted by Step 104. The date information 8 is the typical date information found on a file and the security software 4 can check the date created, the date modified, or any other date information maintained about the file 6. This information can easily be retrieved from the properties information associated with the file. Which date information is retrieved and how much date information is retrieved depends on the configuration of the security software 4.

Once the date information 8 about the file 6 is retrieved, the security software 4 compares 12 the date information 8 to the clean date 10 (Step 106). In Step 108, if the file's 6 date and time information 8 is later than the clean date 10, the security software 4 performs its normal security routines 14 which could include blocking the file if the security software 4 is a firewall or quarantining or deleting the file if the security software is an anti-virus product. If the file's 6 date and time information 8 is earlier than the clean date 10, the security software allows 4 the file 6 to function normally and access the Sites 18 without interruption 16.

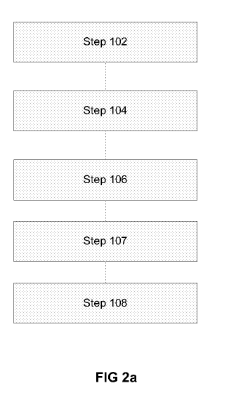

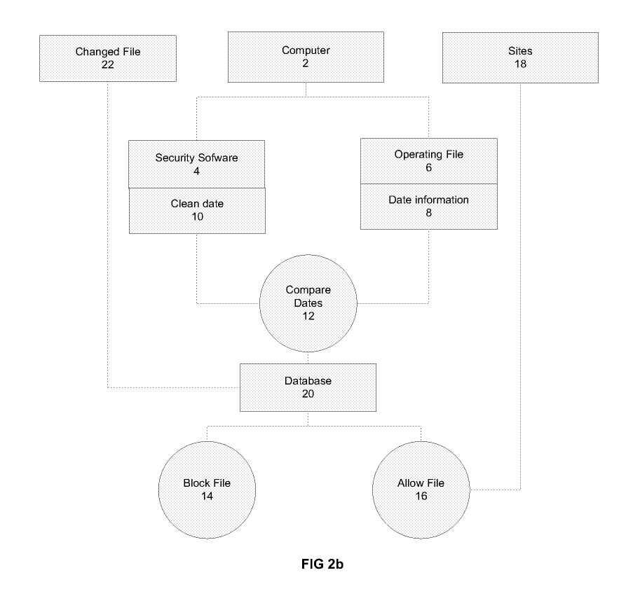

FIG. 2 is an expansion of the embodiment described in Figure and incorporates a database feature 20 that allows the security software 4 to track files that have been modified or changed. Steps 102-108 are the same as described above. The changed files 22 included in the database are known to be safe updates to programs that were already being allowed. Before allowing, blocking, or containing a file in Step 108, the security software 4 first checks the database 20 for the file 6 about to be blocked or contained (Step 107). If the file 6 is found in the database 20, then the security software 4 knows that the file 6 being detected as potentially malicious is actually a safe file that has simply been updated to a new version. The security software 4 then allows the file 6 to perform its typical operation routine without intervention it even though its date is later than the clean date.

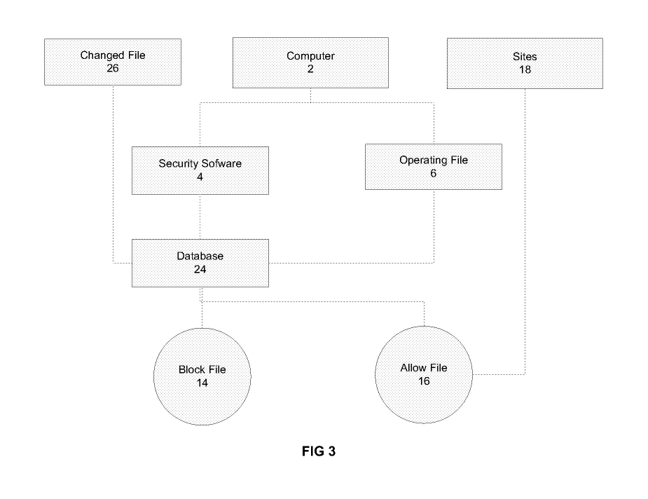

FIG. 3 shows the flowchart of an alternate embodiment where a database 24 is used to record all changed files 26 that meets set criteria. The amount of modification required before the file 26 is included in the database 24 depends on the security software's 4 design or could be left to the user's selection. Changes that could be used as criteria for the inclusion of the file 26 in the security software's database 24 include, but are not limited to, installation of the file, changing the version number, changing the date of the file, modifying the file's name, modifying the file's location, or any other modification to the file's pre-clean mode installation information.

Any files modified and included 24 in the database are automatically considered changed after the clean date which eliminates the need to check and compare date information. Being in the database 24 means that file 6 has been installed, modified, or changed and could be a potential threat. Instead of looking at the file's date information, the security software 4 simply checks the database 24 for the file 6. If the file 6 is included in the database 24, then security software 4 will intervene with the operation of the file 14 according to the security software's normal operating procedure. If the file is not located in the database, then the security software knows the file is safe and allows the application or file to continue operating without interference 16. In other words, even if the date information is spoofed or missing from the file information, the computer is still secure against new threats because the security software 4 is recording all new and/or modified files 26 in the database 24 and only files found in the database are being blocked or restricted.

Optionally, the security software 4 can go back and determine what files 26 should be included in the database 24 by checking each file on the computer's date and time information against the clean date. If the date information is after the clean date, then the security software includes the file in the database for further preventive measures. This scan can be used to ensure the integrity of the database in case the user shuts off the security software for a while or to create a new database of potentially dangerous programs at a new clean date.

If a user desires, they can instruct the security software 4 to remove the file's listing 6 from the database 24 and prevent it from being listed again in the database 24. This can be done by instructing the security software 4 to remover the selection, remember this action, and then apply the same policy every time the file is modified 26. This prevents the security software 4 from re-recording the same set of files 26 in the database each time the file 6 is modified or updated.

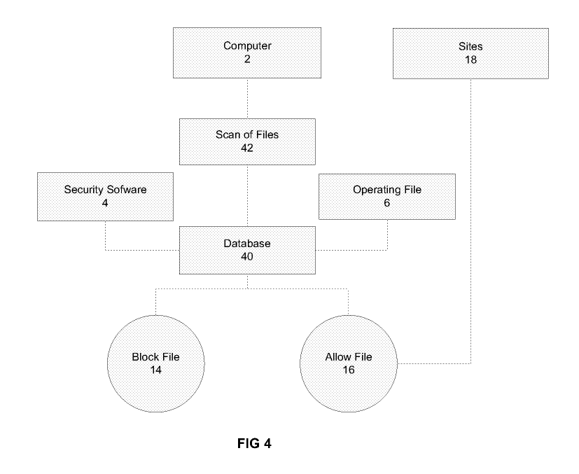

FIG. 4 depicts the flowchart an alternate embodiment. In FIG. 4, after the user enters “clean mode”, the security software 4 scans the computer 42 and records a list of the files already installed on the machine 40. When a file 6 attempts to operate or access the Sites 18, the security software 4 checks to see if the file 6 is included in the database 40. If the file 6 is not found in the database 40 then the file 6 is blocked from further operation 14. If the file 6 is in the database 40, the file 6 is allowed to operate as normal 16. Files not originally in the database can be added to the database later by the user or based on the user's decision of whether or not to allow a file. This is true for each embodiment of the invention. The database or file information can and should be modified to based on the user selection of whether or not the file should actually be allowed or blocked.

In each of the embodiments, the security software can be programmed to only search, record, and prevent certain file types as set by either the programmer or the user. This helps limit the size of the databases, can increase database recordation speeds, and can limit the amount of information and number of files presented to the user as potentially dangerous. For example, the security software can be set to only warn users about or include in a database executables that have been installed or modified after the clean date.

The security software 4 can also be set to check the digital signature or code signing certificate of the file or application 6 to see if the file or the application associated with the file 6 has been signed by a trusted software vendor who is listed in a trusted vendor database. A validly signed file would be allowed even if its date information is after the clean date or if it is included or not included in one of the databases.

It should be recognized that storing a file in a database as used herein includes storing a reference to the file or storing another identifier of the file instead of the file itself All such information may be split over several databases, database fields, or tables without restriction.

It should also be recognized that the disclosed invention can be used in tandem with other know security measures including white lists and black lists. The security software can include a white list of good applications that will not be included in the database or warned about, a black list of known malware, and the invention to limit the risk of any future or unknown threats.

The invention is not restricted to the details of the foregoing embodiments. The invention extend to any novel one, or any novel combination, of the features disclosed in this specification (including any accompanying claims, abstract and drawings), or to any novel one, or any novel combination, of the steps of any method or process so disclosed.

What is claimed is:

1. A method of protecting a computer comprising the steps of
having security software running on a computer
running at least one file,
selecting at least one date associated with the at least one file being run,
comparing the at least one selected date of the at least one file being run to at least one other date, and
interfering with the operation of the at least one file being run if the at least one selected date of the at least one file being run is later than the at least one other date.

2. A method of protecting a computer according to claim 1, where the security software running on a computer is a firewall.

3. A method of protecting a computer according to claim 2, where the interference with the operations of the at least one file being run is blocking the at least one file being run's access to the Internet.

4. A method of protecting a computer according to claim 1, where the security software running on the computer is an anti-virus program

5. A method of protecting a computer according to claim 4, where the interference with the operations of the at least one file being run is terminating the at least one file being run's normal operation.

6. A method of protecting a computer according to claim 4, where the interference with the operations of the at least one file being run is quarantining the at least one file being run from other files on the computer.

7. A method of protecting a computer according to claim 1, where the at least one other date is the date the security software was installed on the computer

8. A method of protecting a computer according to claim 1, where the at least one other date is a date selected by the user.

9. A method of protecting a computer according to claim 1, where the interference with the operation of the at least one file being run only occurs if the at least one file being run is not signed by a valid code signing certificate

10. A method of protecting a computer according to claim 1, where the interference with the operation of the at least one file being run only occurs if the at least one file being run is not included in at least one trust third party database.

11. A method of protecting a computer according to claim 1, where the interference to with the operation of the file being run only occurs if the file being run is a set file-type.

12. A method of protecting a computer comprising the steps of
having security software running on a computer
selecting a date
monitoring the computer for changes made to the computer's file system after the selected date
recording changes to the computer's file system made after the selected date in at least one database
running at least one file,
selecting at least one date associated with the at least one file being run,
comparing the at least one selected date of the at least one file being run to the selected date,
checking the database for a reference to the at least one file being run, and
interfering with the operation of the at least one file being run if the at least one selected date of the at least one file being run is later than the selected date and if a reference to the at least one file being run is not found in the at least one database.

13. A method of protecting a computer according to claim 12, where the security software running on a computer is a firewall.

14. A method of protecting a computer according to claim 13, where the interference with the operations of the at least one file being run is blocking the at least one file being run's access to the Internet.

15. A method of protecting a computer according to claim 12, where the security software is an anti-virus program.

16. A method of protecting a computer according to claim 15, where the interference with the operations of the at least one file being run is terminating the at least one file being run's normal operation.

17. A method of protecting a computer according to claim 15, where the interference with the operations of the at least one selected file is quarantining the at least one file being run from other files on the computer.

18. A method of protecting a computer according to claim 12, where the selected date is the date the security software was installed on the computer.

19. A method of protecting a computer according to claim 12, where the selected date is a date selected by the computer's user.

20. A method of protecting a computer according to claim 12, where the interference with the operation of the at least one file being run only occurs if the at least one file being run is not signed by a valid code signing certificate

21. A method of protecting a computer according to claim 12, where the interference with the operation of the at least one file being run only occurs if the at least one file being run is not included in at least one trust third party database.

22. A method of protecting a computer according to claim 12, where the change in the computer's file system is a change is selected from a group consisting of: renaming at least one file, installing at least one file, changing the version number of at least one file, changing at least one file's location on the computer's harddrive.

23. A method of protecting a computer according to claim 12, where the reference to the at least one file being run is removed from the at least one database upon the security software receiving input from the computer's user.

24. A method of protecting a computer comprising the steps of
having security software running on a computer
monitoring the computer for changes to the file system made after a set date
recording changes to the file system made after a set date in at least one database
running at least one file,
checking the at least one database for a reference to the at least one file, and
interfering with the operation of the at least one selected file if a reference to the at least one file is found in the at least one database.

25. A method of protecting a computer according to claim 24, where the security software running on a computer is a firewall.

26. A method of protecting a computer according to claim 25, where the interference with the operations of the at least one file being run is blocking the at least one file being run's access to the Internet.

27. A method of protecting a computer according to claim 24, where the security software is an anti-virus program.

28. A method of protecting a computer according to claim 27, where the interference with the operations of the at least one file being run is terminating the at least one file being run's normal operation.

29. A method of protecting a computer according to claim 27, where the interference with the operations of the at least one selected file is quarantining the at least one file being run from other files on the computer.

30. A method of protecting a computer according to claim 24, where the set date is the date the security software was installed on the computer.

31. A method of protecting a computer according to claim 24, where the set date is a date selected by the computer's user.

32. A method of protecting a computer according to claim 24, where the interference with the operation of the at least one file being run only occurs if the at least one file being run is not signed by a valid code signing certificate

33. A method of protecting a computer according to claim 24, where the interference with the operation of the at least one file being run only occurs if the at least one file being run is not included in at least one trust third party database.

34. A method of protecting a computer according to claim 24, where the change in the computer's file system is a change is selected from a group consisting of: renaming at least one file, installing at least one file, changing the version number of at least one file, changing at least one file's location on the computer's harddrive.

35. A method of protecting a computer according to claim 24, where the reference to the at least one file being run is removed from the at least one database upon the security software receiving input from the computer's user.

36. A method of protecting a computer according to claim 24, where the change to the file system is only recorded if the change affects a set file-type.

37. A method of protecting a computer according to claim 24, where the interference to with the operation of the file being run only occurs if the file being run is a set file-type.

38. A method of protecting a computer comprising the steps of
having security software running on a computer
scanning the computer for files
recording references to files in at least one database
running at least one file,
checking the at least one database for a reference to the at least one file, and
interfering with the operation of the at least one selected file if a reference to the at least one file is not found in the at least one database.

39. A method of protecting a computer according to claim 38, where the security software running on a computer is a firewall.

40. A method of protecting a computer according to claim 39, where the interference with the operations of the at least one file being run is blocking the at least one file being run's access to the Internet.

41. A method of protecting a computer according to claim 38, where the security software is an anti-virus program.

42. A system comprising:
a computer
security software
a means of determining a clean date
a means of interfering with files modified after the clean date

43. A system according to claim 42, further comprising
a database

44. A system according to claim 43, further comprising
means for monitoring the computer for file changes
means for recording files changes in the database
